(19) United States
(12) Patent Application Publication
(10) Pub. No.: US 2014/0024560 A1
(43) Pub. Date: Jan. 23, 2014

(54) DRILLING FLUID USING SURFACTANT PACKAGE

(71) Applicants: Jose Miguel Gonzalez Poche, Estado Miranda (VE); Franklin Quintero Godoy, Estado Miranda (VE); Rosa Linda Marquez Silva, San Antonio de los Altos (VE); Sergio Rosales, Los Teques (VE); Jesus Enrique Arellano Varela, Los Teques (VE); Harry Wilson Ogalde Arquero, Los Teques (VE); Domingo Pernia, Los Teques (VE)

(72) Inventors: Jose Miguel Gonzalez Poche, Estado Miranda (VE); Franklin Quintero Godoy, Estado Miranda (VE); Rosa Linda Marquez Silva, San Antonio de los Altos (VE); Sergio Rosales, Los Teques (VE); Jesus Enrique Arellano Varela, Los Teques (VE); Harry Wilson Ogalde Arquero, Los Teques (VE); Domingo Pernia, Los Teques (VE)

(73) Assignee: INTEVEP, S.A., Caracas (VE)

(21) Appl. No.: 13/552,925

(22) Filed: Jul. 19, 2012

(51) Int. Cl. C09K 8/06; C09K 8/28; C09K 8/10; C09K 8/08

(52) U.S. Cl. 507/111; 507/136; 507/131; 507/110; 507/112; 507/113; 507/114

(57) ABSTRACT

A drilling fluid, comprising an aqueous continuous phase, and a surfactant system comprising a mixture of an ester phosphate and a non-ionic ethoxylated alcohol. The drilling fluid may also contain one or more of at least one salt, an alkaline material, a viscosifying agent, a starch or starch derivative, a bridging agent, a weighting material, and a diesel oil or non-aromatic oil.

### BACKGROUND OF THE INVENTION

In the oil industry, there are drilling fluids of different nature, classified according to the external fluid phase as: water-based, oil-based, and pneumatic or gas-based systems. Basically, drilling fluids are composed of a base fluid (water or oil), a weighting material and other additives to control rheological properties, fluid losses and shale inhibition, among others. The type of drilling fluid selected for a drilling operation depends on the formation being drilled, the depth, the mechanical resistance and the wellbore's pressure. Regardless of the type of drilling fluid, its main functions are to: maintain hole integrity, transport rock cuttings from bottom hole to the surface, control formation pressure, and cool and lubricate the bottom hole assembly.

The lubricity function is very important, due to the existence of frictional forces during all stages of well construction (drilling, completion and maintenance). Sources of frictional forces include: pipe resistance to rotation (torque) and the raising and lowering movement (drag) inside the well in contact with either the wellbore (metal-to-rock) or the casing (metal-to-metal). These forces can be minimized by increasing the lubricity of the drilling fluid. This can be achieved using lubricant additives, generally available as film producing liquids or solid beads, powders or fibers. Liquid additives include glycols, oils, esters, fatty acid esters, surfactants and polymer-based lubricants. Solid additives include graphite, calcium carbonate flakes, glass and plastic beads. Dealing with torque and drag is a crucial part of well design and well operations, particularly for complex well architectures and extended reach wells. For instance, rig capacity can be compromised by excessive torque, and excessive drag can lead to problems sliding pipe or failure to set the casing or completion string.

In horizontal well drilling operations, the drill string first bores a vertical well, and then at some predetermined point deviates from vertical in the build section. Eventually, the borehole can deviate 90° from vertical to become a horizontal well. The horizontal section of a well is designed to increase wellbore intersection with the oil-bearing formation. The drill string in a horizontal section of the well suffers high torque due to the increased contact between the string and the horizontal wellbore. Horizontal wells are advantageous in heavy oil production due to low mobility of the oil.

A significant portion of heavy oil deposits are found in unconsolidated formations, such as unconsolidated sand. The mixture of heavy oil with this unconsolidated sand results in the adherence of the oil and sand on the drill string and casing. This phenomenon is often referred to as accretion.

The accretion of drill cuttings over the drill string and the casing affects drilling operations by increasing the torque and drag. The entire string can become stuck as a result of the increased drag, which can result in excessive operational costs to drill the hole. Further, due to the unconsolidated nature of some heavy oil formations, it is usually necessary to line the horizontal wellbore by placing a slotted steel liner throughout the horizontal section. The slotted steel liner allows oil production while at the same time limiting the amount of sand coproduced and maintaining the horizontal wellbore integrity. The slotted steel liner is essentially a steel pipe with a typical wall thickness of 12 mm and a diameter close to that of the wellbore. In order for the pipe to be placed in the horizontal section, it must be pushed through the curved build section which will have a steel bore hole casing. If the intermediate casing is coated with drill cutting accretions, significant frictional resistance to landing the liner can be encountered to the point where some wells have had to be abandoned due to the slotted liner becoming immovable.

Treatments have been attempted in field operations to remedy these problems including addition of surfactants to emulsify the heavy oil or prevent accretion, addition of inorganic salts to prevent accretion, addition of cleaning agents based on naturally occurring hydrocarbons and addition of conventional lubricants. Lubricants are commonly used to deal with these problems, reducing the coefficient of friction and, as a consequence they can highly improve the efficiency of drilling operations. These lubricants can be solid or liquid. Solid lubricants work as ball bearings. On the other hand, liquid lubricants create a film which is thick enough to cover surface roughness. Due to the fact that liquid lubricants compete with other surface-active components in the drilling fluids, their performance depends on their concentration. Some solutions for high friction forces include the application of oil-based lubricants. However, none of these treatments has satisfactorily prevented the aforementioned operational difficulties.

In the Orinoco Oil Belt of Venezuela, when drilling extended horizontal sections of wells, problems related to torque and drag are frequently encountered. These problems are produced by adhesion of heavy oil and sand over the drill string. This accretion effect is the main cause of drilling process breakdowns and non-productive time. It can be seen that an additive that would prevent accretion of the heavy oil and sand mixture on metal surfaces while conducting drilling operations in these reservoirs would be desirable and beneficial.

### SUMMARY OF THE INVENTION

This invention presents a novel surfactant system as an additive to a drilling fluid. The surfactant system includes a phosphate ester and non-ionic ethoxylated alcohol that can be used as an anti-accretion and friction reducing additive for water-based drilling fluids. This surfactant system has excellent detergent and wetting properties, and also improves the lubricating properties of water-based drilling fluids, minimizing torque and drag problems that may occur in directional, horizontal and extended reach well drilling operations due to the accretion effect of heavy oil and sand mixtures on metal surfaces.

In addition, this invention presents a new methodology focused on the evaluation and selection of lubricant additives as reducing agents of torque and drag for well drilling operations. The disclosure determines the effectiveness of additives added to water-based drilling fluids in order to improve the lubricating properties of the fluid system and minimize the accretion problems generated during well drilling operations.

These and other features of the invention, preferred embodiments and variants thereof, and further advantages of the invention will become appreciated and understood by those skilled in the art from the detailed description below.

In further accordance with the present invention, a water-based drilling fluid is provided which includes a surfactant system comprising phosphate ester and non-ionic ethoxylated alcohol, at least one salt, and an alkaline source. This surfactant system can be used as an anti-accretion and friction reducing additive. Further additives as known in the art may be added to impart other desired properties to the water-based drilling fluid system. Such known additives include viscosifying agents, filtration control agents, weighting materials, and bridging agents. Other preferred additives are clay-swelling inhibitors and pH controlling components.

According to the invention, the novel surfactant system includes a phosphate ester and non-ionic ethoxylated alcohol that can be used as an anti-accretion and friction reducing additive for water-based drilling fluids. This surfactant system, when added to a drilling fluid has excellent detergent and wetting properties, and also improves the lubricating properties of water-based drilling fluids, minimizing torque and drag problems that may occur in directional, horizontal and extended reach well drilling operations due to the accretion effect of heavy oil and sand mixtures on metal surfaces. This fluid provides significant benefits concerning the decrease of undesired adhesion of heavy oil and sand over the metal surfaces. The lubricity and liquid/liquid/solid compatibility of this drilling fluid are beneficial.

In addition, this invention presents a new methodology focused on the evaluation and selection of lubricant additives as reducing agents of torque and drag for well drilling operations. One objective of this disclosure is to determine effectiveness of additives added to water-based drilling fluids in order to improve the lubricating properties of the fluid system and minimize the accretion problems generated during drilling operations.

In further accordance with the present invention, there is provided a method for drilling a wellbore comprising: operating a drilling assembly to drill a wellbore and circulating a water-based drilling fluid through the wellbore as it is drilled, wherein the water-based drilling fluid includes the novel surfactant system formed by a mixture of a phosphate ester and non-ionic ethoxylated alcohol that can be used as an anti-accretion and friction reducing additive. Further additives as known in the art may be added to impart other desired properties to the water-based drilling fluid system. Such known additives include viscosifying agents, filtration control agents, weighting materials, and bridging agents. Other preferred additives are clay-swelling inhibitors and pH controlling components.

### BRIEF DESCRIPTION OF THE DRAWINGS

A detailed description of preferred embodiments of the invention follows, with reference to the attached drawings, wherein:

FIG. 1 shows the chemical structure of the novel surfactant system that can be used as anti-accretion and friction reducing additive for water-based drilling fluids comprising a mixture of ester phosphate and non-ionic ethoxylated alcohol according to the invention;

FIG. 2 shows the results of liquid/liquid/solid (L/L/S) compatibility tests conducted according to the present invention;

FIG. 3 further illustrates the droplet size distribution for several fluids containing drilling fluid additives;

FIG. 4. depicts the results of liquid/liquid/solid (L/L/S) compatibility tests as a function of the water-based drilling fluid formulations evaluated according to the present invention; and

FIG. 5 shows the results of torque as a function of measured depth obtained in field tests carried out in horizontal well drilling operations using different drilling fluid additives in the Orinoco Oil Belt of Venezuela.

### DETAILED DESCRIPTION

The invention relates to a drilling fluid, and more particularly, to a water-based drilling fluid including as a critical ingredient a novel surfactant system comprising a mixture of an ester phosphate surfactant with non-ionic ethoxylated alcohol. At low concentrations, this surfactant system can help to give the water-based drilling fluid good properties for lubricity which is critical for reducing torque and drag on the drill string, and also good properties in liquid/liquid/solid compatibility which helps to prevent hydrocarbon deposits on the drill string and metal surfaces. The fluid thereby provides improvements in drilling and especially in directional, horizontal and extended reach well drilling operations.

It has been found that a water-based drilling fluid which has a surfactant system according to the invention can substantially reduce the coefficient of friction between metal surfaces such as those typically encountered during directional, horizontal and extended reach well drilling operations. This reduces torque and drag on the drill string during rotation, pick up and slack off of the drill string, and thereby improves efficiency of drilling operations.

A water-based drilling fluid including the surfactant system as lubricant additive according to the invention can preferably exhibit a coefficient of friction, when measured under a constant load of 444.8 N, at a rotary speed between a rotating steel ring and a metal block, immersed in the drilling fluid, of less than about 0.10, and preferably less than about 0.08.

The drilling fluid includes an aqueous continuous phase which may generally be any water based fluid that is compatible with the formulation of a drilling fluid. In one preferred embodiment, the aqueous continuous phase is selected from: fresh water, sea water, brine, mixtures of water and water soluble organic compounds, and mixtures thereof. The amount of the aqueous continuous phase should be sufficient to form a water-based drilling fluid. This amount may range from nearly 100% of the drilling fluid to less than 30% of the drilling fluid by volume.

The surfactant system of the invention comprises an ester phosphate and non-ionic ethoxylated alcohol mixture and is preferably added to the drilling fluid system in an amount between about 0.2 and about 3.0% w/v (weight by volume) of the drilling fluid.

According to the invention the water-based drilling fluid can further comprise at least one salt; and an alkaline material.

The salt can be selected from the group consisting of potassium chloride (KCl), potassium acetate (CH₃CO₂K), sodium chloride (NaCl), calcium chloride (CaCl₂) and mixtures thereof.

The alkaline material can preferably be an amino-alcohol such as monoethanolamine. The monoethanolamine (MEA) is preferably added to the drilling fluid system in an amount between about 0.15 and about 1.0% w/v (weight by volume) of the drilling fluid, which is generally sufficient to provide the desired pH. Examples of other suitable alkaline materials include potassium hydroxide (KOH), sodium hydroxide (NaOH), calcium hydroxide (CaOH₂), sodium carbonate (Na₂CO₃), di-ethanolamine (DEA), tri-ethanolamine (TEA), potassium carbonate (K₂CO₃) and combinations thereof.

The formulation of the water-based drilling fluid may also include diesel oil or non-aromatic mineral oil used as co-lubricant additive which is preferably added to the drilling fluid system in an amount between 0.1 and about 5.0% v/v of the drilling fluid. Further additives as known in the art may be added to impart other desired properties to the fluid system. Such known additives include viscosifying agents, filtrate reducing agents, and weight adjusting agents.

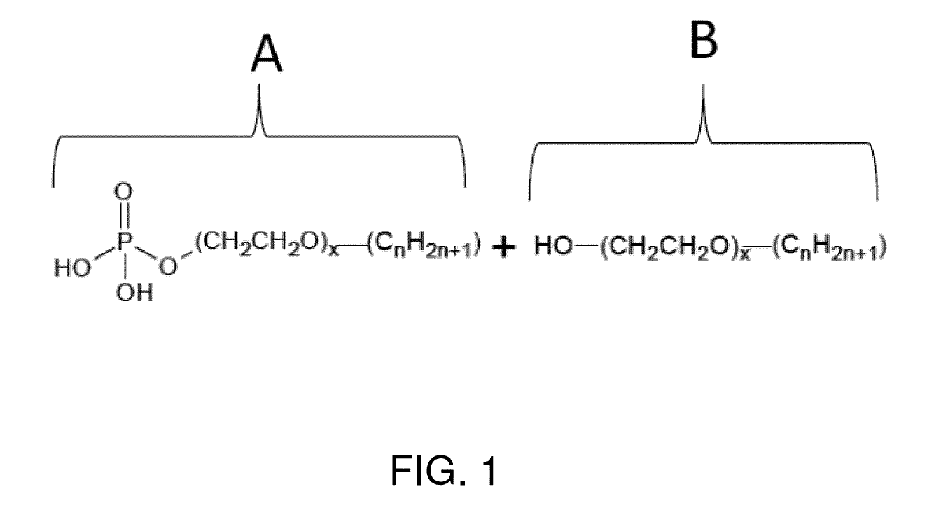

As indicated above, the water-based drilling fluid according to the invention contains an additive in the form of a mixture of an ester phosphate and non-ionic ethoxylated alcohol surfactant. The surfactant mixture of the present invention is preferably the product of a chemical reaction between ethoxylated alcohol and polyphosphoric acid, without further purification or separation. The ethoxylated alcohol is used in excess with respect to the polyphosphoric acid to ensure that all the acid is consumed during the reaction, and this is why the final mixture may contain a high amount of residual ethoxylated alcohol in the final product. The chemical process preferably employs from two to four times excess of ethoxylated alcohol (in mass), minimizing the level of unconverted polyphosphoric acid. The resulting surfactant package is a mixture of ester phosphate (A, FIG. 1) and non-ionic ethoxylated alcohol (B, FIG. 1).

In FIG. 1, the surfactant includes ester phosphate and ethoxylated alcohol each having a grade of ethoxylation, x, which is approximately 3, 6, or 9, and a length of the alkyl hydrocarbons, n, which is between 12 and 14. Thus, in FIG. 1, x preferably equals 3, 6, or 9, and n is preferably between 12 and 14.

The drilling fluid which includes the above surfactant is preferably an aqueous fluid having as a substantial component a water phase. In addition to the lubricant or surfactant additive, as mentioned above, the drilling fluid can advantageously contain at least one salt such as potassium chloride (KCl), potassium acetate (CH₃CO₂K), sodium chloride (NaCl), calcium chloride (CaCl₂) and mixtures thereof or the like, and also can contain an alkaline material, preferably amino-alcohol such as monoethanolamine (MEA) or other alkaline materials such as potassium hydroxide (KOH), sodium hydroxide (NaOH), calcium hydroxide (CaOH₂), sodium carbonate (Na₂CO₃), di-ethanolamine (DEA), tri-ethanolamine (TEA), potassium carbonate (K₂CO₃) and mixtures thereof. These additives help to provide the desired pH preferably between 9 and 11. The drilling fluid may also include diesel oil or non-aromatic mineral oil as co-lubricant additive. Further additives as known in the art may be added to impart other desired properties to the fluid system. Such known additives include viscosifying agents, filtrate reducing agents, and weight adjusting agents, for example.

According to the invention, the surfactant used as an anti-accretion and friction reducing additive for water-based drilling fluids preferably contains between about 20 and about 60% of ester phosphate surfactant and between about 80 and about 40% of ethoxylated alcohol, both taken with respect to weight of the surfactant. This surfactant is helpful in preventing and/or removing excess torque and drag as well as plugging or fouling of a drill string due to adhesion of hydrocarbons to the drill string. This surfactant is preferably present in the water-based drilling fluid in the amount between about 0.2 and about 3.0% w/v, more preferably between about 0.2 and about 0.5% w/v of the drilling fluid.

As mentioned above, one or more salts are preferably included to prevent clay swelling during drilling. Clay swelling can adversely impact conditions in the well due to blocking of pore spaces in the subterranean formation. Salt(s) can be selected from the group consisting of potassium chloride (KCl), potassium acetate (CH₃CO₂K), sodium chloride (NaCl), calcium chloride (CaCl₂) and a mixture thereof, preferably potassium chloride (KCl), and can be used in an amount between about 0.01 and about 5.0% w/v.

The alkaline material mentioned above, which can preferably be an amino-alcohol such as but not limited to monoethanolamine (MEA), is advantageously used as a pH modifier to maintain the pH of the water-based drilling fluid at substantially a basic value, preferably between 9 and 11. Depending upon the other components of the fluid, a suitable amount of alkaline material is preferably added to adjust the pH to the desired value. The monoethanolamine (MEA) is preferably added to the drilling fluid in an amount between about 0.15 and about 1.0% w/v, which is generally sufficient to provide the desired pH. Examples of other alkaline materials include potassium hydroxide (KOH), sodium hydroxide (NaOH), calcium hydroxide (CaOH₂), sodium carbonate (Na₂CO₃), di-ethanolamine (DEA), tri-ethanolamine (TEA), potassium carbonate (K₂CO₃) and combinations thereof.

The drilling fluid of the present invention can also include a viscosifying agent in order to improve the rheological properties of the fluid. Viscosifying agents suitable for use in the formulation of the drilling fluid may be generally selected from any type of viscosifying agents suitable for use in aqueous based drilling fluids. The viscosifying agent would therefore be known to one of skill in the art, and examples include: xanthan gums (which can be clarified or not), scleroglucan (which can be purified or not), starches, modified starches and synthetic viscosifiers such as polyacrylamides, and the like, in amounts between about 0.1% and about 5.0% w/v of the drilling fluid.

A further component of the water-based drilling fluid may be a starch or starch derivative, which advantageously serves to provide fluid loss control. Examples of suitable starch or starch derivative include carboxymethyl starch, hydroxyethyl starch, hydroxypropyl starch, starches cross-linked with etherifying and/or esterifying agents and the like. In addition, the water-based drilling fluid may include a cellulose derivative component which serves to improve rheological properties of the drilling fluid, and also serves to reduce filtration losses. This component can be provided in the form of hydroxypropyl cellulose, carboxymethyl hydroxyethyl cellulose, polyanionic cellulose, hydroxyethyl cellulose, hydrophobically modified cellulose and combinations thereof, in amounts between about 0.1% and about 5.0% w/v of the drilling fluid.

A bridging agent may also be included to achieve good filtration control and low fluid loss, and a particularly preferred bridging agent is calcium carbonate. The size of the calcium carbonate particle is selected to avoid formation damage and also to control fluid loss. Although calcium carbonate serves mainly as a bridging agent and to control fluid loss into the reservoir, calcium carbonate also serves to increase density of the fluid. The bridging agent can be included in amounts between about 1.0% and about 15.0% w/v of the drilling fluid.

The water-based drilling fluid may also include a weighting material in order to increase density of the fluid. Weighting material is added to the drilling fluid in a functionally effective amount largely dependent on the nature of the formation being drilled. Weighting materials suitable for use in the formulation of the water-based drilling fluid may generally be selected from any type of weighting materials in solid particulate form, suspended in solution, dissolved in the aqueous phase as a part of the preparation process or added afterward during drilling. In one illustrative embodiment, the weighting material may be selected from the group consisting of barite, hematite, iron oxide, calcium carbonate, magnesium carbonate, aqueous soluble organic and inorganic salts, and mixtures and combinations of these compounds and the like. Such weighting materials may be utilized in the formulation of drilling fluids in amounts between about 1.0% and about 15.0% w/v of the drilling fluid.

The formulation of the water-based drilling fluid may also include diesel oil or non-aromatic mineral oil used as co-lubricant additive which is preferably added to the drilling fluid system in an amount between about 0.1% and about 5.0% v/v (volume by volume) of the drilling fluid. This co-lubricant additive may be mixed in the aqueous phase as a part of the preparation process, or mixed with the surfactant additive prior to drilling fluid preparation, or added afterward during drilling.

The above components in addition to the surfactant of the invention, when mixed in a water-based drilling fluid advantageously provide a desired detergency and lubricity helping to improve efficiency and more reliable performance during directional, horizontal and extended reach well drilling operations.

As indicated above, the present invention is directed to a water-based drilling fluid containing a novel surfactant system comprising phosphate ester and non-ionic ethoxylated alcohol. Drilling fluid according to the invention can also optionally contain at least one salt, an alkaline source and other additives. The surfactant acts as an anti-accretion and friction reducing additive.

The drilling fluid is useful to inhibit or remove the accretion effect of heavy oil and sand mixtures on metal surfaces and minimize torque and drag problems that may occur in directional, horizontal and extended reach well drilling. In one aspect the drilling fluid can be used in a method for drilling a wellbore through heavy oil reservoirs located in unconsolidated formations. In such method, without the present additive, cuttings can adhere as accretions to the metal surfaces of the drilling assembly, and metal surfaces in the wellbore such as liners and casing. At the same time, accretion of cuttings to the drill string and the casing impairs drilling operations by increasing the torque and drag on the drill string. The entire string can become stuck as a result of the increased drag resulting in excessive operational costs to drill the wellbore. Thus, the present method includes circulating the water-based drilling fluid, as described above, while operating a drilling assembly to drill the wellbore, and thereby helps to avoid the problems described herein.

It will be appreciated that it may not be necessary to use the additive of the present invention in the drilling fluid formulation throughout an entire drilling operation. For example, it may not be required during drilling through over burden. The method is useful during drilling when heavy oil and sand mixtures are being produced as drill cuttings, and very useful where there is more frequent contact between metal surfaces such as, for example, during drilling of the build section and the horizontal section of a wellbore. In addition, if during drilling using a drilling fluid according to the present invention, accretions are being deposited to an undesirable extent, the concentration of the surfactant additive can be increased to inhibit further undesirable amounts of accretion and remove, at least to some degree, those accretions already deposited.

The surfactant mixture of the present invention can be used at any concentration that is effective to inhibit or remove the accretion effect of heavy oil and sand mixtures on metal surfaces and minimize torque and drag problems that may occur in directional, horizontal and extended reach well drilling. This surfactant package is preferably present in the water-based drilling fluid in an amount between about 0.2 and about 3.0% w/v, more preferably between about 0.2 and about 0.5% w/v of the drilling fluid. The alkaline material, which can preferably be an amino-alcohol such as but not limited to monoethanolamine (MEA), is advantageously used as a pH modifier to maintain the pH of the water-based drilling fluid at substantially a basic value, preferably between 9 and 11. Depending upon the other components of the fluid, a suitable amount of alkaline material is preferably added to adjust the pH to the desired value. Monoethanolamine (MEA) is preferably added to the drilling fluid in an amount between about 0.15 and about 1.0% w/v of the drilling fluid, which is generally sufficient to provide the desired pH. The drilling fluid, of course, includes water and additives such as, for example, viscosifying and fluid loss control additives, weighting materials, and bridging agents. Further additives as known in the art may be added to impart other desired properties to the water-based fluid system.

The water-based drilling fluid should also be compatible with clay encountered in the well and/or producing formation to prevent clay swelling or deflocculating which could also cause the pore spaces in the formation to become blocked. For this reason, one or more salts are included and this component advantageously serves to control any such clay swelling or deflocculating.

As mentioned above, the preferred lubricant additive includes a blend of ester phosphate surfactant and non-ionic ethoxylated alcohol, preferably wherein the length of alkyl hydrocarbon chains is C₁₂-C₁₄ and wherein the grade of ethoxilation could be 3, 6, or 9.

Other specific types of surfactant mixtures within this broad genus include: nonionic surfactants chosen from ethoxylated alkyl phenols, ethoxylated alcohols or co-polymers of ethylene oxide, and anionic surfactants such as a phosphonate, phosphate ester of alkanolamine, alkyl aryl sulfonate, alkyl sulfonate, alkyl sulfates, and sulfusuccianates, or sodium salts of these.

### EXAMPLES

Water-based drilling fluids with different lubricant additives were prepared in order to test their properties for lubricity and liquid/liquid/solid (L/L/S) compatibility. Table 1 below shows characteristics of the fluids.

In order to evaluate the effect of each lubricant additive on lubricating properties of water-based drilling fluids, the lubricity coefficient was measured as the coefficient of friction (CF) at room temperature (22-23° C.), using a block-on-ring tribometer (OFITE Lubricity Tester, model 212 EP, OFI Testing Equipment, Inc.) The metal to metal lubricity testing device basically consists of a rotating steel ring against which a metal block can be compressed with variable loads using a torque wrench. Ring and block are immersed in the drilling fluid during the test and the friction force between both is measured. The following procedure was used: applying a constant load (W) 444.8 N by means of the torque arm, adjust the rotational speed of the ring at 60±10 rpm, after 600 s take the ampere reading on the meter which is converted to the CF factor (ANSI/API 13I/ISO 10414-1, 2008). Measurements were performed every 300 s after an equilibrium period of 300 s.

TABLE 1
Lubricant additives evaluated

| Additive | Description | Commercial name | Supplier |
|---|---|---|---|
| A | Fatty acid esters (C₁₂-C₂₂)/alcohol | EZ-GLIDE ™ | HALLIBURTON |
| | (C₂-C₁₂) mixture | | |
| B | Fatty acids (C₁₈-C₂₂) mixture | TOFA | CLARIANT |
| C | Ester phosphate surfactant/ | — | PDVSA |
| | ethoxylated alcohol blend | | Intevep |
| D | Sodium lauryl sulphate/nonyl | INTEFLOW ® | PDVSA |
| | phenol ethoxylated with about | | Intevep |
| | 35 ethylene oxide groups blend | | |
| E | Polyglycolic ether-type | SOLSURF ® | PDVSA |
| | surfactant/polyglycolic ether- | | Intevep |
| | type surfactant/ammonium | | |
| | sulfate lauryl ether blend | | |

The coefficient of friction (CF) was measured in aqueous solutions with 3.0% w/v of each lubricant additive in order to study their behavior and select the additives which had the lowest coefficients of friction. Subsequently, the effect of these additives was evaluated when mixed into a base formulation (F0, blank) having the properties shown in Table 2. The torque reduction percentage in comparison to the reference fluid was determined.

TABLE 2
Description of the base formulation (F0, blank)

| Additive | Concentration (w/v) | Function |
|---|---|---|
| Clarified xanthan gum | 0.43% | Viscosifying agent |
| Polyanionic cellulose | 0.43% | Filtration control |
| Calcium carbonate | 7.14% | Bridging/weighting agent |
| Potassium hydroxide | 0.043% | Adjust pH |
| Bactericide | 0.003% | Prevent bacterial attack |

In order to study the effect of each additive selected on the interaction in the drilling fluid (DF)/heavy crude oil (HCO)/sand (S) system, liquid/liquid/solid (L/L/S) compatibility tests were conducted considering the various elements present in the drilling process. Tests were based on the standard methodology reported by Foxenberg et al. (Foxenberg et al., 1998), mixing the aqueous phase (represented by the drilling fluid prepared with each additive selected in the previous stage) and the oil phase (represented by the heavy crude oil and sand) in a ratio of 50/50 (v/v) at 2,000 rpm for 15 min and 60° C. After 3 hours, the amount of sand separated from the system was quantified and the clean sand and phase behavior was observed qualitatively. Finally, the DF/HCO dispersions were evaluated by measuring the apparent viscosity, droplet size and electrical conductivity, in order to determine the continuous phase and their electrical mobility. Viscosity was measured using a BROOKFIELD viscometer, model LVT at 49° C. (ANSI/API 13I/ISO 10414-1, 2008). Drop diameter (D[4,3]) was determined by a particle size analyzer, MALVERN, Mastersizer Micro model. Electrical conductivity was measured with a pH-meter and conductivity portable, Thermo, ORION 4 STAR model.

Table 3 presents results of lubricity tests of different friction reducing additives (A-E, Table 1) in aqueous solution. Each fluid contained 3.0% w/v of the additive. It can be seen that additives C, A and B showed the lowest coefficients of friction with values of CF=0.08, CF=0.09 and CF=0.11, respectively.

TABLE 3
Coefficient of friction of the aqueous solution for lubricant additives
evaluated

| | Additive | | | | |
|---|---|---|---|---|---|
| | A | B | C | D | E |
| Coefficient of friction | 0.09 | 0.11 | 0.08 | 0.17 | 0.14 |

Based on results obtained and presented in Table 3, four formulations were prepared incorporating drilling fluid additives with best performance. The four formulations are listed in Table 4 below.

TABLE 4
Water-based drilling fluids formulations evaluated in lubricity
tests

| Formulation | Description |
|---|---|
| F1 | F0 + 10.0% v/v diesel oil |
| FA | F0 + 3.0% w/v additive A |
| FB | F0 + 1.0% w/v additive B |
| FC | F0 + 1.0% w/v additive C |

The coefficient of friction was measured as outlined above. The F1 formulation corresponds to the base formulation (F0, blank) used traditionally in the area, which contains 10.0% v/v of diesel oil as lubricant additive. The formulation FA refers to F0 formulation with 3.0% w/v of the additive A. Additionally, the FB and FC formulations, corresponding to the additives B and C, were prepared with a concentration of 1.0% w/v because of the optimal behavior present in this concentration interval. The lubricity behavior of the latter formulations was compared with that obtained by the F1 formulation. The results in terms of friction coefficient and torque reduction percentage with respect to F1 formulation are summarized in Table 5.

TABLE 5
Coefficient of friction and torque reduction percentage with respect to F1
formulation

| | Formulation | | | |
|---|---|---|---|---|
| | F1 | FA | FB | FC |
| Coefficient of friction | 0.25 | 0.06 | 0.10 | 0.08 |
| Torque reduction | — | 76.0% | 60.0% | 68.0% |

The results presented in Table 5 show that formulations FA and FC, prepared with additives A and C, have a similar performance decreasing the coefficient of friction with respect to F1 formulation. The coefficient of friction is similar for both additives (0.06 and 0.08, respectively), and the torque reduction percentage in comparison to F1 formulation is close to 70%. The effectiveness of these additives (based on specific blends of surfactants) in this type of application is mainly due to the formation of a thick and strong film that protects the surface, and is capable of withstanding high compressive forces, and in this way reduces the friction forces between mechanical or metal parts. This significantly reduces the torque generated during operations.

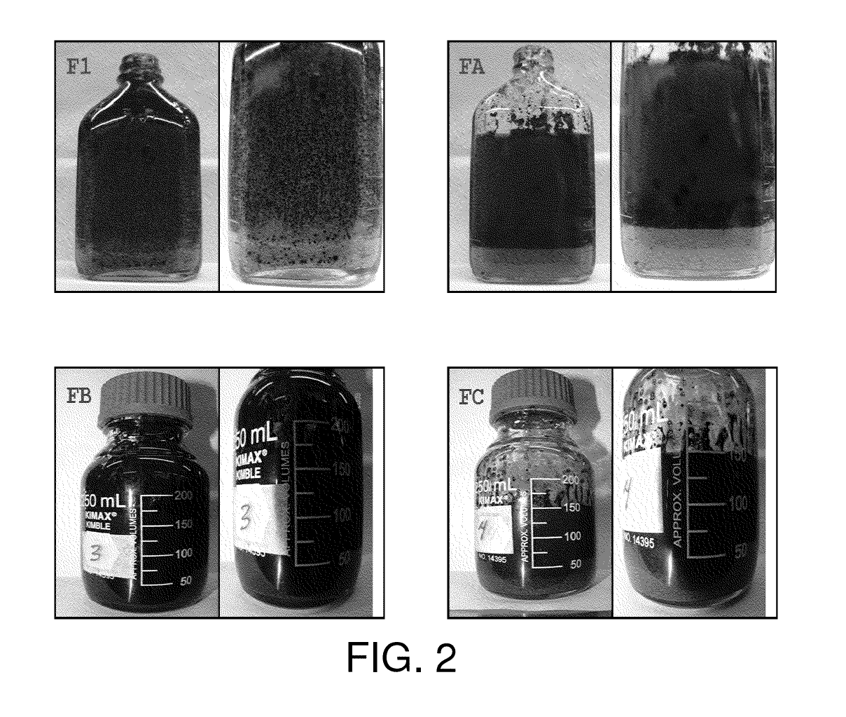

Liquid/liquid/solid (L/L/S) compatibility tests were conducted with the F1, FA, FB and FC formulations. The results obtained are shown in FIG. 2. In the case of F1 formulation, at the upper zone of the dispersion, large droplets are observed between heavy crude oil and drilling fluid, while at the lower zone, sand with little presence of crude oil is observed. In the case of FA formulation, it shows stable oil in water (O/W) emulsion with low viscosity, and at the lower zone, it is observed that the sand was separated from the heavy crude oil mixture, without any oil droplet attached onto the sand. The FB formulation also presents a stable oil in water (O/W) emulsion, but at the lower zone of the bottle sand and wall are impregnated with heavy crude oil. Finally, the FC formulation also produced stable oil in water (O/W) emulsion, and the lower zone had less contaminated sand. Also, the walls at the top of the bottle are cleaner than in the previous cases, with few residuals of stuck heavy oil.

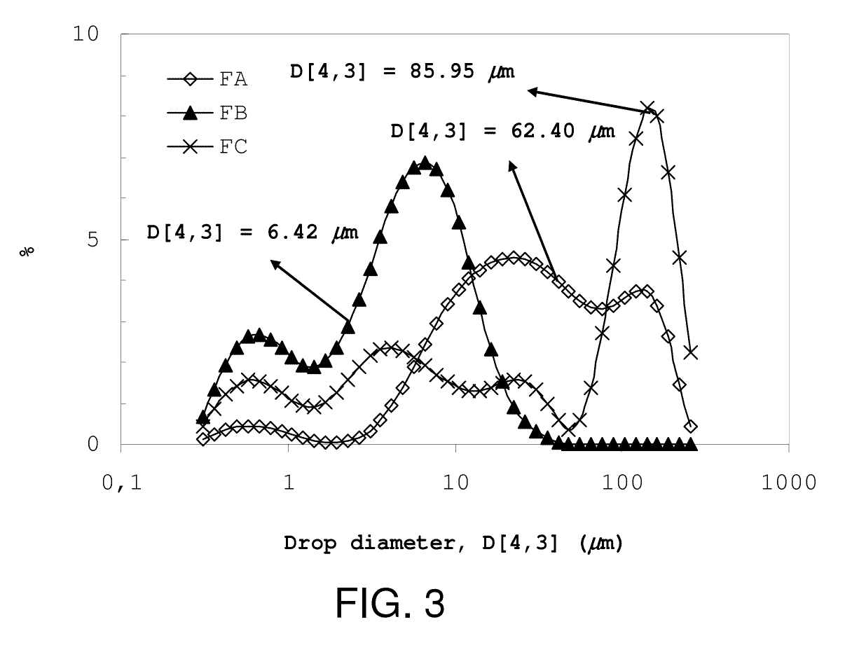

The apparent viscosity, drop diameter and electrical conductivity values of the DF/HCO dispersions are summarized in Table 6. FIG. 3 shows the droplet size distribution curves obtained.

TABLE 6
Apparent viscosity, drop diameter and electrical conductivity
for DF/HCO dispersions

| | | | | | Distilled |
|---|---|---|---|---|---|
| Formulation | FA | FB | FC | HCO | water |
| Apparent | 1,100 | 1,700 | 2,100 | 64,000 | — |
| viscosity (cP) | | | | | |
| Drop diameter, | 62.40 | 6.42 | 85.95 | — | — |
| D [4,3] (μm) | | | | | |
| Electrical | 3.80 | 1.12 | 2.26 | — | 0.30 |
| conductivity | | | | | |
| (mS/cm) | | | | | |

Results presented in Table 6 show that, in all cases, DF/HCO dispersions obtained had lower apparent viscosity than original heavy crude oil. In addition, it was observed that the FB formulation has a high tendency to create stable O/W emulsions with low drop diameter and bimodal distribution curves. Also, FA and FC formulations showed tendency to create O/W emulsions, but with high drop diameter and polydisperse distribution curves, thereby promoting quick destabilization (FIG. 3). Finally, DF/HCO dispersions obtained have higher electrical conductivity than distilled water, and as a consequence, they show continuous phase water.

Other water-based drilling fluids with lubricant additives A and C were prepared in order to test their properties at high temperatures for lubricity and liquid/liquid/solid (L/L/S) compatibility. Equally, the effect of these additives was evaluated when mixed into a base formulation (FX, blank) having the properties shown in Table 7.

TABLE 7
Description of the base formulation (FX, blank) evaluated at
high temperatures

| Additive | Concentration (w/v) | Function |
|---|---|---|
| Xanthan gum | 0.57% | Viscosifying agent |
| Starch | 0.57% | Filtration control |
| Calcium carbonate | 8.57% | Bridging/weighting agent |
| Sodium hydroxide | 0.02-0.10% | Adjust pH |

Based on the results obtained and presented in Tables 5-6 and FIG. 3, six additional formulations were prepared incorporating additives A and D. The six formulations are listed in Table 8 below.

TABLE 8
Water-based drilling fluids formulations evaluated at high temperatures

| Formulation | Description |
|---|---|
| FX2 | FX + 20.0% v/v diesel oil |
| FXA | FX + 3.0% w/v additive A |
| FXC1 | FX + 0.71% w/v additive C |
| FXC2 | FX + 1.00% w/v additive C |
| FXC3 | FX + 1.29% w/v additive C |
| FXC4 | FX + 0.51% w/v additive C + 0.77% v/v diesel oil |

According to Table 8, the FX2 formulation corresponds to the base formulation (FX, blank) with 20.0% v/v of diesel oil. The formulation FXA refers to FX formulation with 3.0% w/v of the additive A. Additionally, the FXC1, FXC2 and FXC3 formulations correspond to FX formulation with 0.71%, 1.00% and 1.29% w/v of the additive C respectively, in order to study the effect of the surfactant concentration on the properties and performance of the fluid system. The formulation FXC4 refers to FX formulation with 0.51% w/v additive C and 0.77% v/v of diesel oil as co-lubricant additive.

The evaluation was to measure rheological properties and the coefficient of friction (CF) of water-based drilling fluids prepared (Table 8), and then subjecting them at high temperatures (150° F.=65.56° C.) for 16 hours (ageing). At the end of the test, rheological properties and the coefficient of friction were measured again, and compared to the results obtained before and after ageing (ANSI/API 13 I/ISO 10414-1, 2008; OFI Testing Equipment, 2009). The lubricity behavior of the latter formulations was compared with that obtained by the FX2 formulation by determining the torque reduction percentage.

The effect of each additive selected on the interaction in the drilling fluid (DF)/heavy crude oil (HCO)/sand (S) system, and as a consequence, liquid/liquid/solid (L/L/S) compatibility tests were conducted as outlined above (Foxenberg et al., 1998). In this case, the aqueous phase (represented by each water-based drilling fluid presented in Table 8) and the oil phase (represented by the heavy oil and sand) were mixed in a ratio of 50/50 (v/v) at 2,000 rpm for 15 min and 60° C. After 3 hours, the amount of sand separated from the system was quantified and qualitatively clean sand and phase behavior was observed.

Table 9 presents results of rheological properties after ageing at 150° F. (65.56° C.) for 16 hours of different water-based drilling fluids tested (Table 8). It can be seen that formulations FXC1, FXC2, FXC3 and FXC4, based on the surfactant system of the present invention, do not produce major changes in rheological properties of the fluid system in comparison to formulations FX2 (with diesel oil as co-lubricant additive) and FXA (prepared with additive A, EZ-GLIDE™, commercial product supplied by HALLIBURTON). These results evidence that the surfactant system of the invention can be used in water-based drilling fluids without significantly affecting rheological properties and stability.

TABLE 9
Rheological properties of water-based drilling fluids formulations
tested at high temperatures (after aging at 150° F.)

| | Formulations | | | | | |
|---|---|---|---|---|---|---|
| Properties | FX2 | FXA | FXC1 | FXC2 | FXC3 | FXC4 |
| L600/L300, | 35/29 | 34/28 | 40/30 | 39/30 | 37/29 | 33/27 |
| [lbf/100 ft²] | | | | | | |
| L200/L100, | 26/23 | 26/22 | 27/23 | 26/21 | 26/22 | 25/23 |
| [lbf/100 ft²] | | | | | | |
| L6/L3, | 11/10 | 11/10 | 11/10 | 10/9 | 13/11 | 14/12 |
| [lbf/100 ft²] | | | | | | |
| Plastic viscosity, PV | 6 | 6 | 10 | 9 | 8 | 6 |
| [cP] | | | | | | |
| Yield point, YP | 23 | 22 | 20 | 21 | 21 | 21 |
| [lbf/100 ft²] | | | | | | |
| Gels 10 sec/10 min, | 10/10 | 11/12 | 10/11 | 10/10 | 11/11 | 12/12 |
| [lbf/100 ft²] | | | | | | |

The lubricity behavior of the latter formulations was compared with that obtained by the FX2 formulation. Results obtained in terms of the coefficient of friction and torque reduction percentage with respect to F1 formulation are summarized in Table 10.

TABLE 10
Coefficient of friction and torque reduction
percentage with respect to FX2 formulation

| Formulation | FX2 | FXA | FXC1 | FXC2 | FXC3 | FXC4 |
|---|---|---|---|---|---|---|
| Coefficient of | 0.26 | 0.21 | 0.25 | 0.25 | 0.11 | 0.14 |
| friction | | | | | | |
| Torque reduction | — | 21.0% | 3.0% | 4.5% | 58.7% | 44.4% |

Results presented in Table 10 show that the coefficient of friction for the formulation FX2 is CF=0.26. It should be noticed that the surfactant system of the invention comprising phosphate ester and non-ionic ethoxylated alcohol is able to reduce the coefficient of friction up to 59% (formulation FXC3, prepared with 1.29% w/v additive C), where its effectiveness depends on the surfactant concentration in the drilling fluid. In addition, it can be seen that diesel oil may be used as co-lubricant additive by decreasing the coefficient of friction up to 44% (formulation FXC4, prepared with 0.51% w/v additive C and 0.77% v/v diesel oil). These results improve the performance of the water-based drilling fluids tested in comparison to additive A (EZ-GLIDE™, supplied by HALLIBURTON).

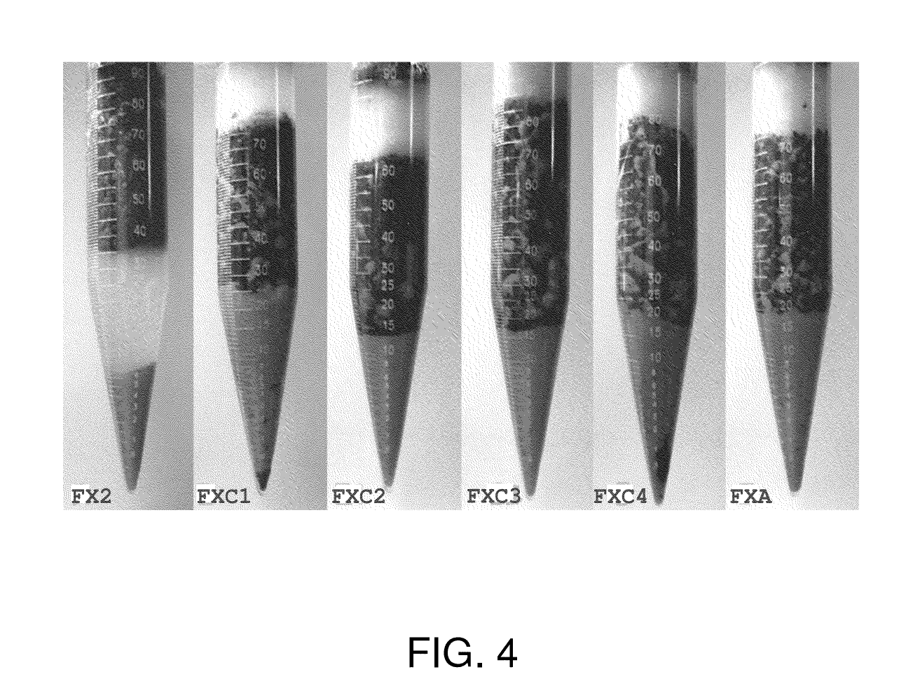

Results obtained in liquid/liquid/solid (L/L/S) compatibility tests are summarized in Table 11 and FIG. 4. It is observed that the water-based drilling fluids formulated with the surfactant system of the invention (formulations FXC1-FXC4) produce comparable and in some cases higher sand volume separated in comparison to formulations FX2 and FXA.

TABLE 11
Sand volume separated in liquid/liquid/solid (L/L/S) compatibility tests
as a function of the water-based drilling fluid formulations tested

| Formulation | FX2 | FXA | FXC1 | FXC2 | FXC3 | FXC4 |
|---|---|---|---|---|---|---|
| Sand volume | 6 | 20 | 25 | 15 | 15 | 20 |
| separated (mL) | | | | | | |

A method was developed for evaluating lubricant additives as agents for reducing torque and drag in well drilling operations in the Orinoco Oil Belt (Venezuela). This methodology includes lubricity tests to measure the coefficient of friction of additives to be evaluated, as well as liquid/liquid/solid compatibility tests to study the effect of each additive selected on the interaction in the drilling fluid (DF)/heavy crude oil (HCO)/sand (S) system.

Results obtained through the method of the invention allow demonstrating that the surfactant system of the present invention (phosphate ester and non-ionic ethoxylated alcohol mixture, additive C) can be used as an anti-accretion and friction reducing additive for water-based drilling fluids. This surfactant system has excellent detergent and wetting properties which inhibit the formation of heavy crude oil and sand mixtures, and also reduces the coefficient of friction by approximately 70% in comparison to the reference water-based drilling fluid used in the area, minimizing torque and drag problems that may occur in directional, horizontal and extended reach well drilling operations due to the accretion effect of heavy oil and sand mixtures on metal surfaces. In addition, this surfactant additive promotes the formation of oil-in-water (O/W) emulsions with low viscosity and high drop diameters, which would facilitate their fast destabilization.

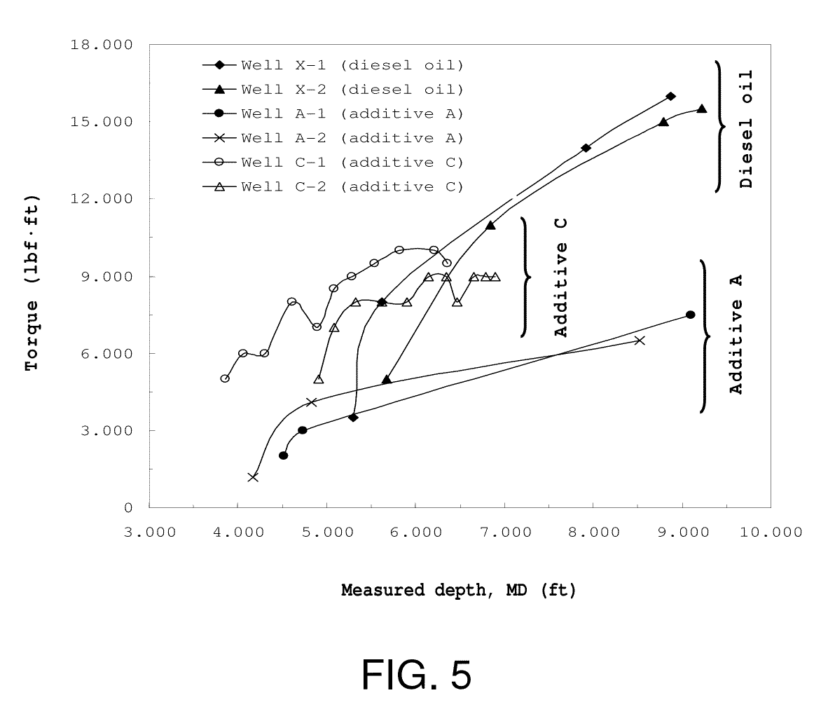

Performance of the surfactant system of the invention (phosphate ester and non-ionic ethoxylated alcohol mixture, additive C) has been successfully validated in more than 70 field tests in horizontal well drilling operations in the Orinoco Oil Belt (Venezuela). Results obtained have allowed verifying the reduction of torque values recorded (FIG. 5) in comparison to other additives traditionally used in the area (diesel oil and EZ-GLIDE™, supplied by HALLIBURTON). It is important to note that a loss of large drilling fluid volumes in the solids control equipment is avoided due to avoidance of the problems with plugging of meshes in screens. As a consequence, the present invention reduces the environmental impact associated with conventional processes.

Adding the surfactant system of the invention (phosphate ester and non-ionic ethoxylated alcohol mixture, additive C) in the water-based drilling fluid has shown the following advantages: a) reduced torque and drag values, which would facilitate horizontal well drilling operations by reducing associated risks and problems to slide pipes or setting casing or completion string, and additional pipe trips; b) lower coefficient of friction in comparison to other additives traditionally used in the area; c) minimal effect on rheological and filtration control properties of the drilling fluid; d) excellent detergent and wetting properties that minimize accretion problems of heavy oil and sand mixtures on metal surfaces; e) reduction of problems related to plugging of meshes in screens of solids control equipment avoiding loss of large drilling fluid volumes, and as a consequence, reduced environmental impact; and f) increasing productive time and saving operational costs.

It should be readily apparent that a water-based drilling fluid has been provided which includes a novel surfactant system comprising a phosphate ester and non-ionic ethoxylated alcohol which is highly effective in minimizing drag and accretion problems during directional, horizontal and extended reach well drilling operations.

The above description has been given in terms of a preferred embodiment of the invention. Modification of details therein would be apparent to a person skilled in the art after reading same. The invention is therefore not to be limited by the details provided herein, but rather defined by the scope of claims appended hereto.

What is claimed:

1. A drilling fluid, comprising:
an aqueous continuous phase; and
a surfactant system comprising a mixture of an ester phosphate and a non-ionic ethoxylated alcohol.

2. The fluid of claim 1, further comprising:
at least one salt; and
an alkaline material.

3. The fluid of claim 1, further comprising at least one additional additive selected from the group consisting of viscosifying agents; starch or starch derivatives; bridging agents; weighting materials; diesel or non-aromatic oils and combinations thereof.

4. The fluid of claim 1, wherein the surfactant mixture is the product of a chemical reaction between ethoxylated alcohol and polyphosphoric acid, without further purification or separation.

5. The fluid of claim 4, wherein the ethoxylated alcohol is used in excess with respect to the polyphosphoric acid to ensure that all acid is consumed during the reaction.

6. The fluid of claim 4, wherein the chemical reaction employs from two to four times excess of ethoxylated alcohol by mass.

7. The fluid of claim 1, wherein the ester phosphate has the following chemical structure: 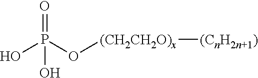
where:
x is the number of ethylene oxide units present in the molecule, and x=3, 6 or 9; and n is length of the alkyl hydrocarbon, and n=12-14.

8. The fluid of claim 1, wherein the non-ionic ethoxylated alcohol has the following chemical structure.
HO—(CH₂CH₂O)ₓ—(CₙH₂ₙ₊₁)
where:
x is the number of ethylene oxide units present in the molecule, and x=3, 6 or 9; and n is length of the alkyl hydrocarbon, and n=12-14.

9. The fluid of claim 1, wherein the surfactant package contains between about 20 and about 60% of ester phosphate surfactant and between about 80 and about 40% of ethoxylated alcohol, both taken with respect to weight of the surfactant package.

10. The fluid of claim 1, wherein the surfactant package is added to the drilling fluid in an amount between about 0.2 and about 3.0% w/v (weight by volume).

11. The fluid of claim 3, wherein the salt is selected from the group consisting of potassium chloride (KCl), potassium acetate (CH₃CO₂K), sodium chloride (NaCl), calcium chloride (CaCl₂) and mixtures thereof.

12. The fluid of claim 2, wherein the at least one salt is in an amount between about 0.01 and about 5.0% w/v of the drilling fluid.

13. The fluid of claim 2, wherein the alkaline material is an amino-alcohol.

14. The fluid of claim 13, wherein the amino-alcohol is monoethanolamine (MEA).

15. The fluid of claim 14, wherein the fluid has a pH of between 9 and 11.

16. The fluid of claim 15, wherein the monoethanolamine (MEA) is in the fluid in an amount between about 0.15 and about 1.0% w/v.

17. The fluid of claim 2, wherein the alkaline material is selected from the group consisting of potassium hydroxide (KOH), sodium hydroxide (NaOH), calcium hydroxide (CaOH₂), sodium carbonate (Na₂CO₃), di-ethanolamine (DEA), tri-ethanolamine (TEA), potassium carbonate (K₂CO₃) and combinations thereof.

18. The fluid of claim 3, wherein the fluid contains the viscosifying agent.

19. The fluid of claim 18, wherein the viscosifying agent is selected from the group consisting of xanthan gums, scleroglucan, starches, modified starches, synthetic viscosifiers, and combinations thereof.

20. The fluid of claim 3, wherein the fluid contains the starch or starch derivative.

21. The fluid of claim 20, wherein the starch or starch derivative is selected from the group consisting of carboxymethyl starch, hydroxyethyl starch, hydroxypropyl starch, starches cross-linked with etherifying and/or esterifying agents and combinations thereof.

22. The fluid of claim 3, wherein the fluid includes a cellulose derivative component selected from the group consisting of hydroxypropyl cellulose, carboxymethyl hydroxyethyl cellulose, polyanionic cellulose, hydroxyethyl cellulose, hydrophobically modified cellulose and combinations thereof.

23. The fluid of claim 3, wherein the bridging agent is calcium carbonate in an amount between about 1.0% and about 15.0% w/v of the drilling fluid.

24. The fluid of claim 3, wherein the weighting material is in a solid particulate form, suspended in solution, dissolved in the aqueous phase as a part of the preparation process or added afterward during drilling, and
wherein the weighting material is selected from the group consisting of barite, hematite, iron oxide, calcium carbonate, magnesium carbonate, aqueous soluble organic and inorganic salts, and mixtures thereof.

25. The fluid of claim 3, wherein the diesel oil or non-aromatic mineral oil is present in an amount between about 0.1% and about 5.0% v/v of the drilling fluid.

26. A drilling method, comprising the steps of:
conducting a drilling operation to drill a wellbore through a heavy oil reservoir; and
circulating the drilling fluid of claim 1 in the wellbore during drilling.

27. The method of claim 24, wherein the wellbore is a directional, horizontal or extended reach well.
